(19) United States
(12) Patent Application Publication
(10) Pub. No.: US 2024/0351876 A1
(43) Pub. Date: Oct. 24, 2024

(54) THERMALLY STABLE POROUS MEMBRANE AND ITS MANUFACTURING METHOD

(71) Applicant: Korea University Research and Business Foundation, Seoul (KR)

(72) Inventors: Jung-Kyu CHOI, Seoul (KR); Se-Jin KIM, Seoul (KR)

(73) Assignee: Korea University Research and Business Foundation, Seoul (KR)

(21) Appl. No.: 18/621,446

(22) Filed: Mar. 29, 2024

(30) Foreign Application Priority Data
Mar. 31, 2023 (KR) 10-2023-0043081

(51) Int. Cl. C01B 3/50; B01D 53/22; B01D 67/00; B01D 69/02; B01D 69/10; B01D 69/14

(52) U.S. Cl. CPC C01B 3/503; B01D 53/228; B01D 67/00793; B01D 67/0086; B01D 69/02; B01D 69/105; B01D 69/148; B01D 2256/16; B01D 2257/504; B01D 2323/081; B01D 2323/14; B01D 2323/2189; B01D 2325/04; B01D 2325/22; B01D 2325/54; C01B 2203/0405

(57) ABSTRACT

The present disclosure relates to a porous membrane and a method of manufacturing the same, and more particularly, to a thermally stable porous membrane capable of securing thermal stability and long-term stability of gas separation performance at high temperatures, and a manufacturing method thereof. This invention is related to a porous membrane comprising: a first Zeolitic Imidazolate Fragments (ZIFs) part formed on a surface of a porous support; and a second ZIFs part embedded in the porous support, wherein the second ZIFs part is formed in a state in which it penetrates from an interface between the first ZIFs part and the second ZIFs part to a predetermined depth.

### FIELD

The present disclosure relates to a porous membrane and a method of manufacturing the same, and more particularly, to a thermally stable porous membrane capable of securing thermal stability and long-term stability of gas separation performance at high temperatures, and a manufacturing method thereof.

### DESCRIPTION OF RELATED ART

Most hydrogen is produced as a mixture of carbon monoxide and carbon dioxide by reacting with water, which is called a water gas shift (WGS) reaction. This reaction is thermodynamically exothermic, but the reaction proceeds at a high temperature corresponding to 200-500° C. to secure a high reaction rate. Since it is an exothermic reaction, the equilibrium conversion rate to hydrogen at a high temperature is limited, and a separation membrane reactor capable of separating hydrogen generated through the reaction at the same time as the reaction has been proposed. This is because, in the conversion of the equilibrium state, only hydrogen is selectively removed through the wall of the membrane reactor, thereby converting the equilibrium state to a more generated state. Since the reaction proceeds at the high temperature as described above, it is essential to secure the technical ability for the high thermal stability of the membrane that acts as a wall in the membrane reactor.

Zeolitic Imidazolate Framework-8 (hereinafter referred to as ZIF-8) membranes have been formed with a pore size of 0.34 nm, which allows for the separation of hydrogen (0.289 nm) and carbon dioxide (0.33 nm) based on size differences. The separation capability of H2/CO2 by ZIF-8 membranes can be confirmed in various documents (R. Krishna and J. M. van Baten, J. Membr. Sci., 2010, 360, 323-333; Q. Liu et al., J. Am. Chem. Soc., 2013, 135, 17679-17682).

One of the synthesis methods for ZIF-8 membranes, the counter-diffusion method, involves controlling the ratio of the diffusion speed and reaction rate of Zn2+ ions and 2-methylimidazole molecules, which are components of ZIF-8. Zn2+ ions are located inside a porous support, while 2-methylimidazole molecules are outside, diffusing in opposite directions due to concentration differences. At the surface of the porous support, the two materials meet to form ZIF-8 particles, thereby synthesizing the membrane. The resulting ZIF-8 membrane exhibits high separation factors in the separation of propylene/propane (H. T. Kwon and H. K. Jeong, J. Am. Chem. Soc., 2013, 135, 10763-10768).

Although current technologies for ZIF membranes primarily focus on new methods of membrane synthesis, to apply them in actual Water-Gas Shift (WGS) reactions, it is necessary to ensure thermal and long-term stability of gas separation performance at high temperatures (200-500° C.).

In an effort to resolve these issues, the inventors have proposed “A Method for Manufacturing a Selective Porous Separation Membrane and a Gas Separation Method Using the Manufactured Porous Membrane” in Korean Registered Patent No. 10-1905862 (Patent Document 1). In Patent Document 1, a γ-Al₂O₃ layer with a different pore size (pore size: 5 nm) was coated on a porous α-Al₂O₃ support (pore size: 150 nm) to delay the diffusion speed of Zn2+ ions and selectively synthesize the ZIF-8 membrane inside the support.

However, the ZIF-8 membrane produced according to Patent Document 1 maintained stable gas separation performance at up to 300° C. for a maximum of 10 hours, which still does not meet the actual requirements.

### Prior Art

### Patent Literature

(Patent Document 1) KR 10-1905862 B1

### SUMMARY

### Problems to be Solved

An object of the present invention is to provide a thermally stable porous membrane capable of securing thermal stability and long-term stability of a gas separation performance at a high temperature, and a method for manufacturing the same.

### Means to Solve the Problems

The embodiment of the present invention provides a porous membrane comprising: a first Zeolitic Imidazolate Fragments (ZIFs) part formed on a surface of a porous support; and a second ZIFs part embedded in the porous support, wherein the second ZIFs part is formed in a state in which it penetrates from an interface between the first ZIFs part and the second ZIFs part to a predetermined depth.

Furthermore, the present invention provides a method for separating hydrogen from a mixed gas of H₂ and CO₂ or from synthesis gas (syngas) using the aforementioned porous membrane.

In an embodiment, the method of separating hydrogen using the porous membrane can be performed at temperatures ranging from 100 to 500° C.

Moreover, the present invention provides a method for manufacturing the porous membrane. This method includes the steps of pre-depositing and immobilizing a Zn precursor using a first concentration of a zinc salt solution on the surface and inside of the porous support; and reacting the Zn precursor-coated porous support with an imidazole or imidazole derivative solution, whereby a first ZIFs part is formed on the surface of the porous support and a second ZIFs part is embedded inside the porous support. The second ZIFs part is characterized by being formed to penetrate to a certain depth from the interface between the first ZIFs part and the second ZIFs part.

In this embodiment, the first ZIFs part has a thickness of 0.1 μm to 10 μm, preferably 1 μm to 5 μm, more preferably 2 μm to 4 μm, and most preferably approximately 3 μm. The second ZIFs part can penetrate to a depth of 10 μm to 500 μm from the interface between the first and second ZIFs parts, preferably 50 μm to 200 μm, more preferably 70 μm to 150 μm, and most preferably about 80 μm.

Controlling the thickness of the first and second ZIFs parts within these ranges ensures high thermal stability of the separation membrane, which acts as a wall in the membrane reactor. It has been found that even after polishing, which will be discussed later, the first ZIFs part maintains stable separation performance.

In this embodiment, the first ZIFs part and the second ZIFs part can be formed by first pre-depositing and immobilizing a Zn precursor using a first concentration of a zinc salt solution on the surface and inside of the porous support, followed by reacting the Zn precursor-coated porous support with an imidazole or imidazole derivative solution.

In this embodiment, the first concentration can range from 0.27 M to 0.58 M, preferably 0.38 M to 0.51 M, most preferably about 0.48 M.

The pre-deposition and immobilization of the Zn precursor can be achieved by immersing the porous support in the zinc salt solution for 1 to 12 hours, preferably 2 to 8 hours, most preferably 2 to 4 hours, and then drying the zinc precursor-coated porous support in a vacuum oven at temperatures ranging from 30 to 200° C., preferably 30 to 120° C., most preferably 40 to 60° C., and even more preferably about 50° C. for 1 to 24 hours, preferably 2 to 15 hours, most preferably 2 to 4 hours.

As the immersion time increases, the amount of Zn precursor adsorbed onto the porous support may also increase. Consequently, it is advisable to appropriately adjust the drying time and drying temperature in the vacuum oven to accommodate this increase.

The reaction with the imidazole or imidazole derivative solution can involve immersing the zinc precursor-coated porous support in the imidazole or imidazole derivative solution and then reacting it at temperatures between 5° and 200° C., preferably 110 to 130° C., most preferably about 120° C. for 1 to 72 hours, preferably 1 to 24 hours, most preferably 2 to 15 hours, and even more preferably about 2 to 4 hours to form the crystals of Zn and imidazole on the surface and inside of the porous support.

In one embodiment, the zinc salt may be selected from a group consisting of zinc nitrate, zinc acetate, zinc chloride, zinc sulfate, zinc bromide, and zinc iodide.

In another embodiment, the imidazole or imidazole derivative used may be selected from a group consisting of benzimidazole, 2-methylimidazole, 4-methylimidazole, 2-methylbenzimidazole, 2-nitroimidazole, 5-nitrobenzimidazole, and 5-chlorobenzimidazole.

In another embodiment, the solution of zinc salt or imidazole or imidazole derivative may be dissolved in one or more solvents selected from a group consisting of methanol, ethanol, propanol, isopropanol, tert-butanol, n-butanol, methoxyethanol, ethoxyethanol, dimethylacetamide, dimethylformamide, N-methyl-2-pyrrolidone (NMP), formic acid, nitromethane, acetic acid, and distilled water.

In another embodiment, the surface of the porous support may be polished a specific number of times. When the porous support surface is polished between 20 to 100 times, preferably 30 to 90 times, it can exhibit a H₂/CO₂ separation factor of 3.1 to 3.8 at 200° C.

In another embodiment, the membrane according to this invention can maintain its separation performance for 36 to 168 hours, preferably 72 to 120 hours, and most preferably for 72 hours, at temperatures ranging from 300 to 360° C.

### Advantageous Effects

As observed in the embodiments discussed, this invention involves depositing and immobilizing a Zn precursor on the surface and inside of a porous support, followed by the synthesis of a ZIF-8 membrane. This approach enables the formation of a separation membrane within the interior of the porous support, thus preventing direct exposure of the membrane to high-temperature gases. Consequently, compared to existing ZIF-8 membranes, this method enhances the thermal and long-term stability of gas separation performance at high temperatures.

### BRIEF DESCRIPTION OF THE DRAWINGS

FIG. 1 shows the planar and cross-sectional SEM images of Z_Znα according to an embodiment of the invention.

FIG. 2 displays the planar and cross-sectional SEM images of Zna according to an embodiment of the invention.

FIG. 3 illustrates the XRD patterns of Z_Znα and Z_Znxa according to an embodiment of the invention.

FIG. 4 is a schematic diagram of each immersion and surface polishing process according to an embodiment of the invention.

FIG. 5 depicts the separation performance of Z_Znα according to an embodiment of the invention.

FIG. 6 shows the XRD pattern of Z Zna after a thermal stability test according to an embodiment of the invention.

FIG. 7 illustrates the temperature-dependent separation performance of the Z_Znα membrane according to an embodiment of the invention.

FIG. 8 compares the H₂/CO₂ separation performance of Z_Znα and other ZIF-8 membranes reported in the literature according to an embodiment of the invention.

FIG. 9 shows the H₂/CO₂ separation performance of Z_Znα and other ZIF-8 membranes reported in the literature according to an embodiment of the invention.

FIG. 10 shows the XRD patterns of Znα, Zn_{0.75}a, Zn_{0.38}α, and Zn_{0.19}α according to an embodiment of the invention.

FIG. 11 displays the XRD pattern of Z_Znα with the simulated XRD pattern of ZIF-8 below it according to an embodiment of the invention.

FIG. 12 presents the EDX line scan results for zinc at different locations on the Z Zna membrane according to an embodiment of the invention.

FIG. 13 shows the planar SEM images of α-Al₂O₃ disc, Zn_{0.75}α, Zn_{0.38}α, and Zn_{0.19}α according to an embodiment of the invention.

FIG. 14 displays the planar SEM images of Z_Zn_{0.75}α, Z_Zn_{0.38}α, and Z_Zn_{0.19}α according to an embodiment of the invention.

FIG. 15 depicts the XRD pattern of the Znα sample after methanol immersion and surface grinding according to an embodiment of the invention.

FIG. 16 shows the planar SEM images of the Znα support after methanol immersion and the Znα support after sandpaper grinding according to an embodiment of the invention.

FIG. 17 displays the planar SEM image of the ZIF-8 membrane formed from the methanol-immersed Znα sample according to an embodiment of the invention.

FIG. 18 illustrates the planar SEM image of the ZIF-8 membrane formed from the polished Znα sample and the corresponding H₂/CO₂ separation factor according to an embodiment of the invention.

FIG. 19 depicts the temperature-dependent H₂/CO₂ separation performance of Z_Zn_{0.75}° C., Z_Zn_{0.38}α, and Z_Zn_{0.19}α according to an embodiment of the invention.

FIG. 20 shows the H₂/CO₂ separation performance of four independent Z_Znα membranes measured over a maximum of 72 hours at 300° C. according to an embodiment of the invention.

FIG. 21 is a graph showing the results of a long-term hydrothermal stability test on Z_Zn α under an equimolar wet H₂/CO₂ mixture supply for up to about 22 hours at 300° C. according to an embodiment of the invention.

FIG. 22 displays the XRD patterns of Z_Znα and Z_Znα after the hydrothermal stability test at 300° C. indicated in FIG. 21 according to an embodiment of the invention.

### DETAILED DESCRIPTION

The description about the presented exemplary embodiments is provided so as for those skilled in the art to use or carry out the present invention. Various modifications of the exemplary embodiments will be apparent to those skilled in the art. General principles defined herein may be applied to other exemplary embodiments without departing from the scope of the present disclosure. Accordingly, the present invention is not limited to the exemplary embodiments presented herein. The present invention shall be interpreted within the broadest meaning range consistent to the principles and new characteristics presented herein

In this specification, when one component is mentioned as being “on” another component, it implies that it can be directly formed on the other component or that a third component may intervene between them. Additionally, in the drawings, the thicknesses of membranes and regions are exaggerated for clear technical explanation.

Furthermore, terms such as “first,” “second,” and “third” are used to describe various components in different embodiments within this specification; however, these components should not be limited by these terms. These terms are merely used to distinguish one component from another. Therefore, a component referred to as “first” in one embodiment might be referred to as “second” in another. Each embodiment described and exemplified here also includes its complementary embodiments. Moreover, the term “and/or” used in this specification means that it includes at least one of the components listed before and after.

In the specification, the use of the singular does not exclude the plural unless explicitly stated otherwise by the context. Terms such as “comprise” or “include,” and any variations thereof, are intended to cover the specified features, numbers, steps, components, or combinations thereof, and should not be understood to exclude the presence or addition of one or more other features, numbers, steps, components, or combinations thereof.

Additionally, detailed descriptions of well-known functions and configurations that are deemed to unnecessarily obscure the essence of the invention have been omitted in the following description of the invention.

In the present invention, the conventional CD method is further improved by pre-depositing a Zn precursor or source on the surface and inside of a porous α-Al₂O₃ support before a solvothermal reaction with a ligand solution and fixing it through drying. In particular, the resulting immobilization of the Zn precursor at the support surface and inside was effective to achieve high dispersion of the Zn precursor, thus ensuring growth of ZIF-8 particles deep inside the porous support. In particular, the pre-deposited Zn precursor plausibly induces the formation of a continuous separation layer on the support, thereby enabling the formation of a dense film inside the support. This membrane configuration was advantageous for resisting thermal decomposition and mechanical damage. In addition, in order to obtain an optimal separation membrane structure, important factors such as the loading amount and position of the Zn precursor that determine the separation membrane preparation were systematically investigated. In particular, the characterized membrane structure showed a high relationship with the H₂/CO₂ separation performance measured at various temperatures. We also evaluated the H₂/CO₂ separation ability of the structured ZIF-8 membrane at a WGS reaction temperature of 300° C. In addition, a long-term stability test was performed to evaluate the possibility of application of the ZIF-8 membrane in an integrated WGS membrane reactor, and the results were compared with those reported in the prior art. Finally, the effect of water vapor on membrane damage, introduced to simulate the WGS reaction conditions, was investigated.

ZIF-8 membranes have emerged as promising wall candidates for use in membrane reactors. This membrane can enhance the WGS reaction performance due to its excellent thermal stability and remarkable H₂/CO₂ sieving ability.

The present invention proposes a modified interdiffusion method for forming an unprecedented thermally stable ZIF-8 membrane. Modified interdiffusion methods include pre-deposition of a zinc precursor (zinc acetate dihydrate) and solvothermal reaction with a methanol solution of the subsequent ligand (2-methylimidazole). The pre-deposition and drying of the Zn precursor on the surface and inside of the porous support appears to play an important role in retarding the diffusion of the Zn source, leading to a primary contact between the Zn source and the ligand molecules in the porous support. As a result, it is likely that a continuous ZIF-8 layer has formed on the upper surface, more preferably at the interface with the particles of the porous support, and has reached a penetration depth (thickness) of approximately 80 μm. Therefore, this enables effective blocking and high dispersion of the support pores by the ZIF-8 particles.

In particular, the resulting ZIF-8 membrane exhibited a maximum H₂/CO₂ separation factor of about 8.7 at a WGS reaction temperature of about 300° C. Unlike conventional membrane structures, ZIF-8 particles were densely embedded inside the porous support to reduce the risk of mechanical damage. The unique membrane structure was also desirable to ensure excellent thermal stability for stable and sustainable H₂/CO₂ separation at 300° C. for up to 72 hours.

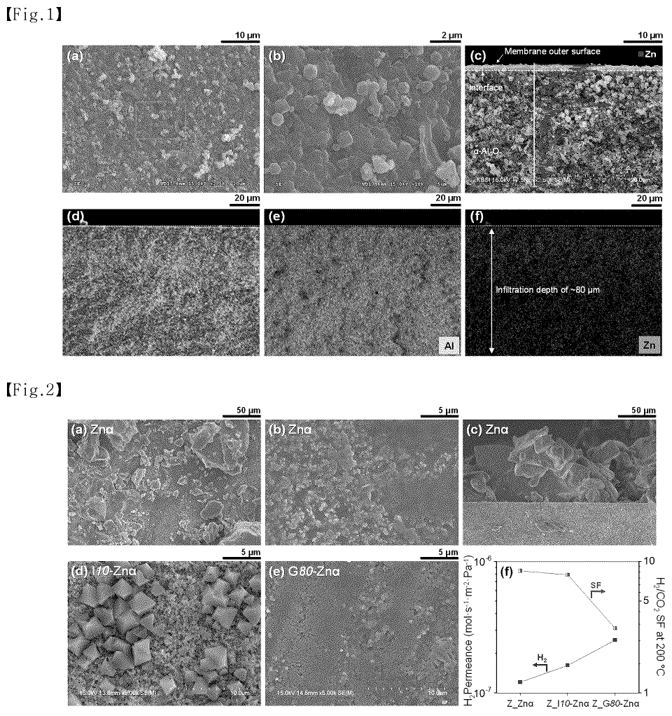

FIG. 1 shows SEM images of (a)-(b) plane and (c)-(f) cross-section of Z_Znα according to an embodiment of the present invention, in FIG. 1(a), a region of a dotted box (indicated by “b”) is enlarged and displayed in FIG. 1(b), and in FIG. 1(c), an EDX elemental line scan result for Zn is displayed (red), and in FIGS. 1(e) and 1(f), a result of a wide-scale EDX mapping (Al in FIG. 1(e) and Zn in FIG. 1(f)) is displayed, which helps to show ZIF-8 particles grown inside a porous support.

FIG. 2 shows (a)-(b) plane and (c) cross-sectional SEM images of Znα according to an embodiment of the present invention, wherein FIG. 2(b) is an enlarged plane SEM image of a Znα portion without bulk ZA particles at the top of the outer surface, FIG. 2(d)-(e) is a plane SEM image of (d) a Znα sample (i.e., G80-Znα) post-treated by dipping (i.e., I10-Znα) in methanol for 10 minutes and (e) 80 times grinding with sandpaper, and FIG. 2(f) is a Z_I10-Zn (SF) and H₂ permeability of Z_Znα, aZ_G80-Zn and a H₂/CO₂ separation factor (SF) measured for a binary H₂/CO₂ mixture feed at 200° C.

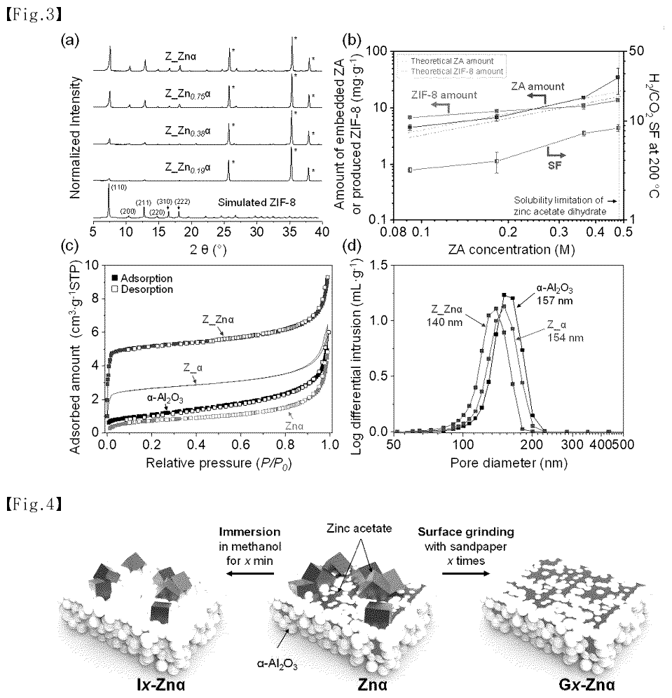

FIG. 3(a) is a diagram showing XRD patterns (x=0.75, 0.38, and 0.19) of Z_Znα and Z_Znxα according to an embodiment of the present invention, wherein the simulated XRD pattern of ZIF-8 in FIG. 3(a) is displayed at the bottom and an asterisk (*) indicates an XRD peak occurring in the α-Al₂O₃ disk, FIG. 3(b) shows amounts of α-Al₂O₃ disk and ZA included in ZIF-8 produced as a function of ZA concentration in solution with corresponding H₂/CO₂ SF for equimolar H₂/CO₂ binary mixture supply at 200° C., purple and blue dashed lines indicate theoretically calculated amounts of ZA and produced ZIF-8, respectively, the theoretical amounts of ZA and ZIF-8 indicate that the Zn precursor completely occupied the pores of the α-Al₂O₃ support (for ZA amount) and the precursor completely converted to ZIF-8 in the Zn-containing support (for ZIF-8 amount) were obtained using the respective assumptions, FIG. 3(c) shows an isotherm of N2 adsorption of the α-Al₂O₃ disk, Znα, and Z_Zn samples at 77K, and FIG. 3(c) shows an isotherm of N2 adsorption reported in FIG. 3(c) It is the pore size distribution obtained from the measurement of the mercury porosity of a, aa and Z_Al₂O₃ Z_Zn α α, and the average value of each pore diameter is provided in FIG. 3(d).

FIG. 4 is a schematic diagram of each dipping and surface polishing process according to an embodiment of the present invention, showing a Zn source-containing α-Al₂O₃ disk (i.e., Znα) (center) obtained after dipping in 0.48 M ZA solution, a post-treated Znα sample (i.e., 1x-Znα, where x represents the dipping time in minutes) after further dipping Znα in methanol (left), and a post-treated Znα sample (i.e., Gx-Znα, where x represents the number of surface polishing steps) after polishing the outer surface of Znα with sandpaper (right).

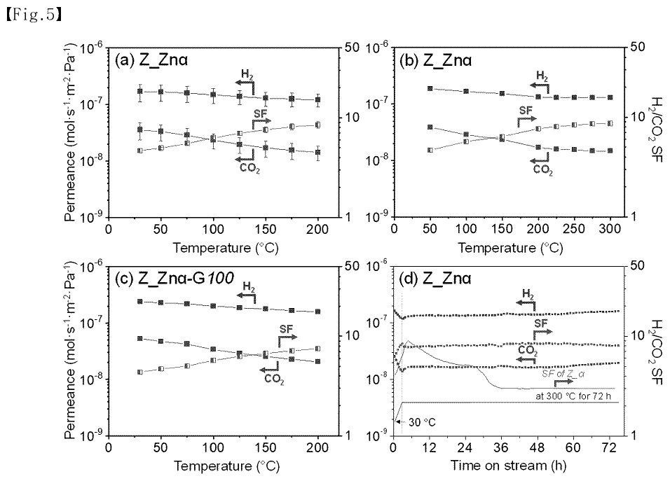

FIG. 5(a) shows the separation performance of Z_Znα as a function of temperature up to 200° C. for equimolar H₂/CO₂ binary mixture feeds, three independent Z_Znα membrane samples were used for reliable measurements, error bars represent the standard deviation, FIG. 5(b) shows the separation performance of Z_Znα as a function of temperature up to 300° C. for equimolar H₂/CO₂ binary mixture feeds, FIG. 5(c) shows the α separation performance of Z_ZnG100-H₂/CO₂ made of Znα whose surface was polished 100 times with sandpaper, FIG. 5(d) is the result of the long-term thermal stability test of H₂/CO₂ Z_Zn at 300° C. for 72 hours for equimolar a binary mixture feeds, and FIG. 5(d) shows the temperature profile used in the thermal stability test (red line) and also included a of Z_H₂/CO₂ SF as a function of the previously reported time on stream for comparison.

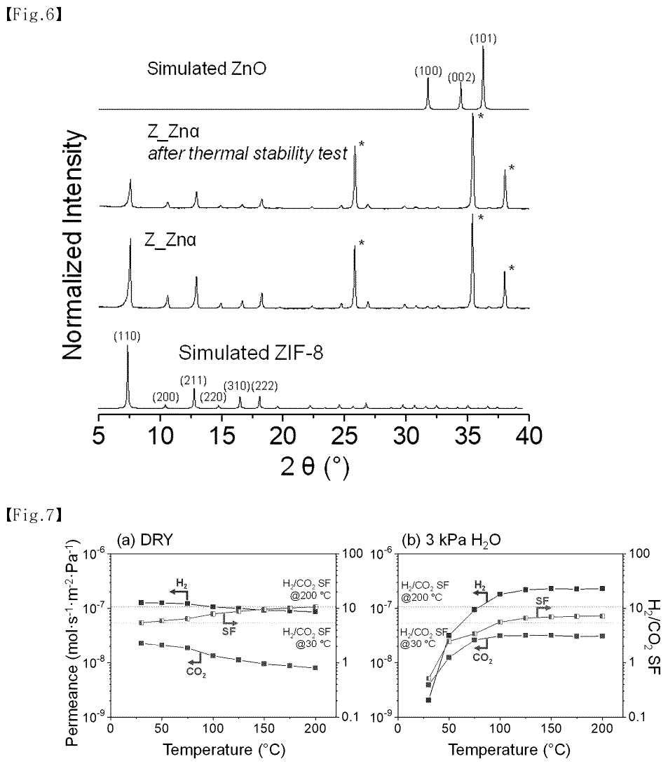

FIG. 6 shows XRD patterns of Z_Znα according to an example of the present invention and Z_Znα after the thermal stability test shown in FIG. 5D, simulated XRD patterns of ZIF-8 and ZnO are shown at the bottom and top, respectively, and an asterisk (*) shows an XRD peak generated from the α-Al₂O₃ disk.

FIG. 7 shows the temperature-dependent separation performance of the Z_Znα membrane for equimolar H₂/CO₂ mixture under dry and wet conditions (a) and (b) according to an exemplary embodiment of the present invention, and for convenience, the red and blue-green dotted lines in (a) and (b) were added, and the H₂/CO₂ separation performance was shown at 200° C. (10.7) and 30° C. (5.5), respectively, under dry conditions.

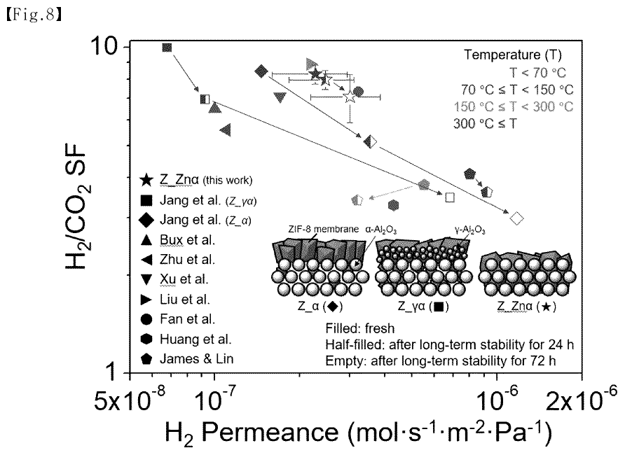

FIG. 8 shows the H₂/CO₂ separation performance of Z_Znα according to an embodiment of the present invention and other ZIF-8 membranes reported in the literature, the permeation measurement temperature (T) for clarity is divided into various colors: T<70° C. (blue), 70° C.≤T<150° C. (green), 150° C.≤T<300° C. (orange), 300° C. ST (red), filled symbols show the performance obtained in new membranes, half filled symbols and open symbols show the performance measured after long-term thermal stability testing for 24 hours and 72 hours, respectively, where five independent Z_Znα membrane samples were used for reliability, and the error bars show the corresponding standard deviation.

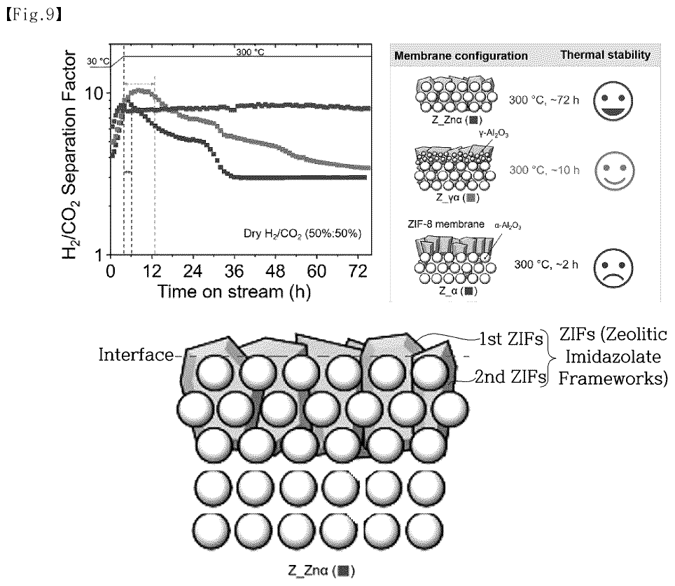

FIG. 9 shows the H₂/CO₂ SF of Z_Znα according to an embodiment of the present invention and other ZIF-8 membranes reported in the existing literature, and for clarity, the Z_Znα membrane of the present invention is classified into blue, the Z_γα membrane synthesized using a porous support having a hierarchical structure is classified into red, and the general ZIF-8 membrane synthesized using an existing porous support is classified into black.

FIG. 10 is a diagram showing XRD patterns of Znα, Zn0.75α, Zn0.38α, and Zn0.19α according to an embodiment of the present invention, and for comparison, a simulated XRD pattern of zinc acetate (ZA) is displayed at the bottom, and an asterisk (*) shows an XRD peak generated from a α-Al₂O₃ disk.

FIG. 11 is a diagram showing an XRD pattern of Z_Znα and a simulated XRD pattern of the lowest ZIF-8 according to an embodiment of the present disclosure, and an asterisk (*) indicates an XRD peak generated from an α-Al₂O₃ disk.

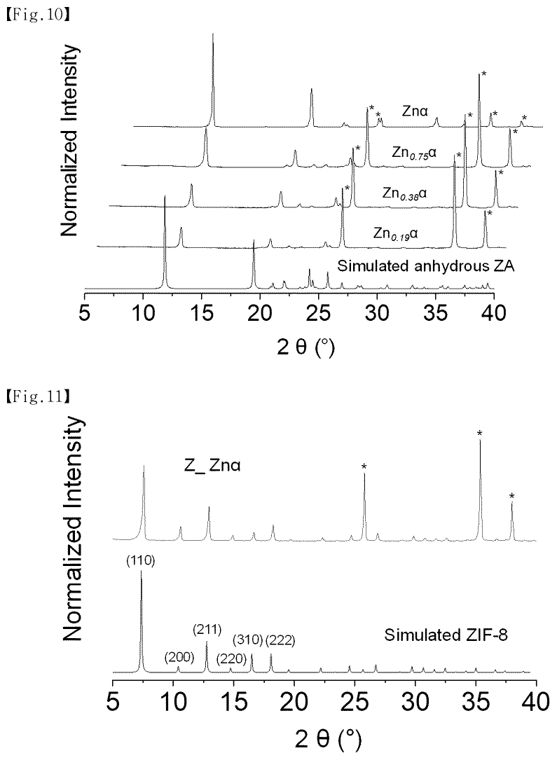

FIG. 12 is a view illustrating EDX line scan results for Zn at different positions of a Z_Znα membrane according to an embodiment of the present disclosure.

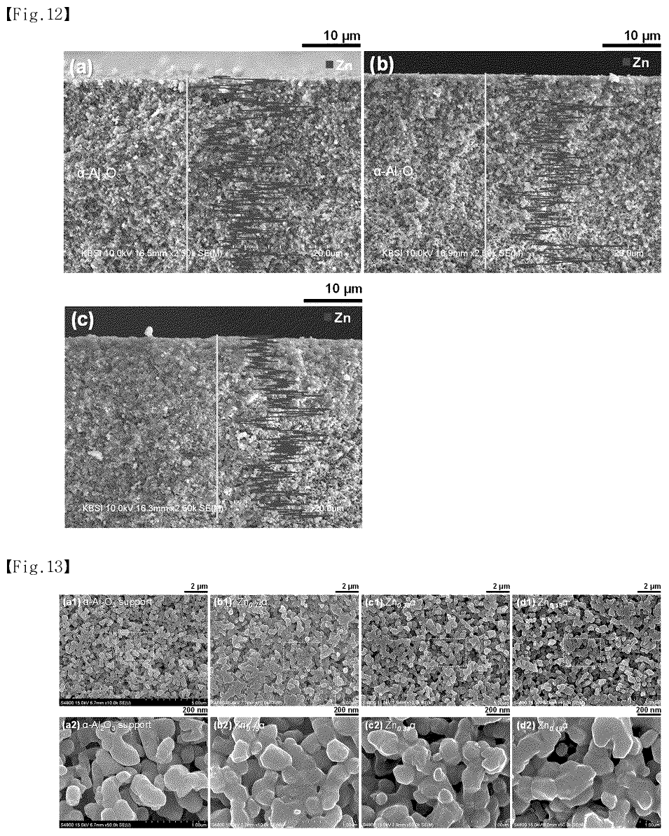

FIG. 13 is a planar SEM image of (a1)-(a2) α-Al₂O₃ disk, (b1)-(b2) Zn0.75α, (c1)-(c2) Zn0.38α, and (d1)-(d2) Zn0.19α according to an embodiment of the present invention, and areas marked with yellow dashed-line boxes in (a1)-(d1) are enlarged and marked in (a2)-(d2).

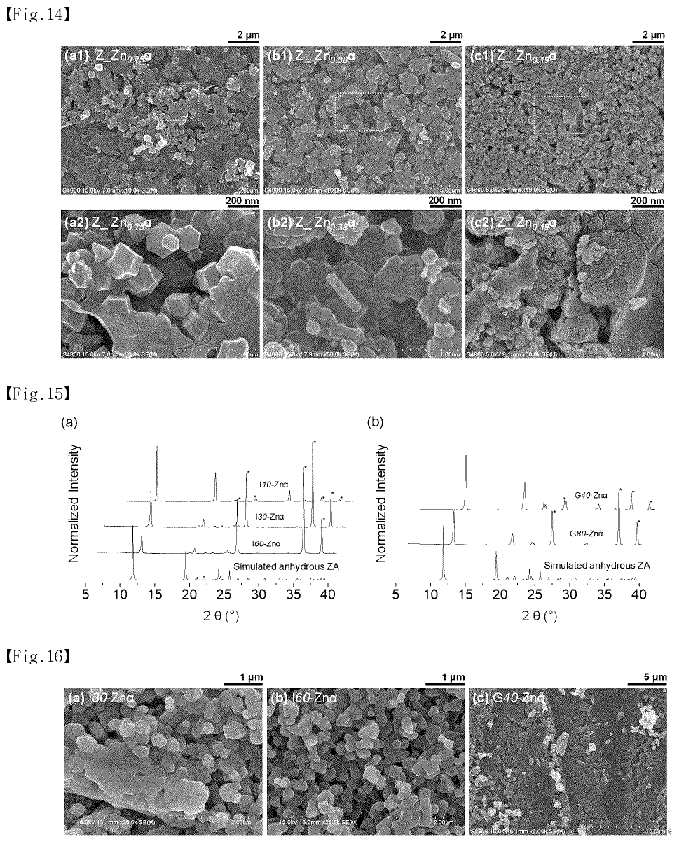

FIG. 14 shows planar SEM images of (a1)-(a2) Z_Zn0.75α, (b1)-(b2) Z_Zn0.38α, and (c1)-(c2) Z_Zn0.19α according to an embodiment of the present invention, and regions indicated by yellow dashed boxes in (a1)-(c1) are enlarged and indicated in (a2)-(c2).

FIG. 15 shows an XRD pattern of a Znα sample after methanol immersion and surface grinding (a) according to an embodiment of the present invention, a simulated XRD pattern of anhydrous zinc acetate (ZA) for comparison is shown at the bottom, and an asterisk (*) shows an XRD peak generated from a α-Al₂O₃ disk.

FIG. 16 is a planar SEM image of a Znα support after methanol immersion for 30 minutes and 60 minutes (a) and a planar SEM image of a Znα support after grinding 40 times with sandpaper, according to an embodiment of the present invention.

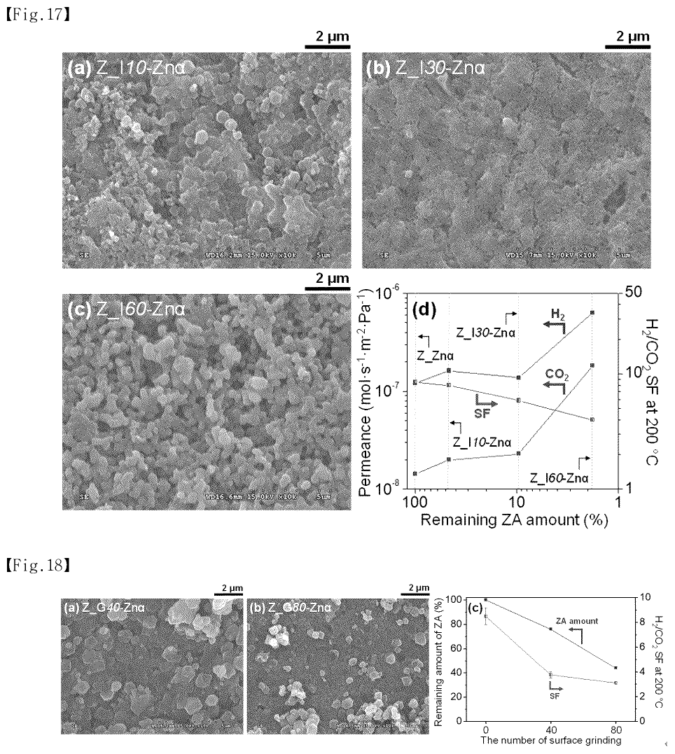

FIG. 17 is a planar SEM image of a ZIF-8 film formed from Znα samples immersed in methanol for 10 minutes (a), 30 minutes (b), and 60 minutes (c) according to an exemplary embodiment of the present invention, (d) H₂/CO₂ separation performance of a ZIF-8 membrane ((a)-(c)) grown on a methanol-treated Znα support (indicated by (a)-(c)), and (d) H₂/CO₂ separation performance of Z_Znα is added based on the remaining ZA amount (corresponding to 100%).

FIG. 18 shows a planar SEM image of a ZIF-8 film formed from (a) 40 th and (b) 80 th polished Znα samples and (c) the corresponding H₂/CO₂ SF according to an embodiment of the present invention, and for comparison, (c) also shows the remaining amount of experimentally measured ZA.

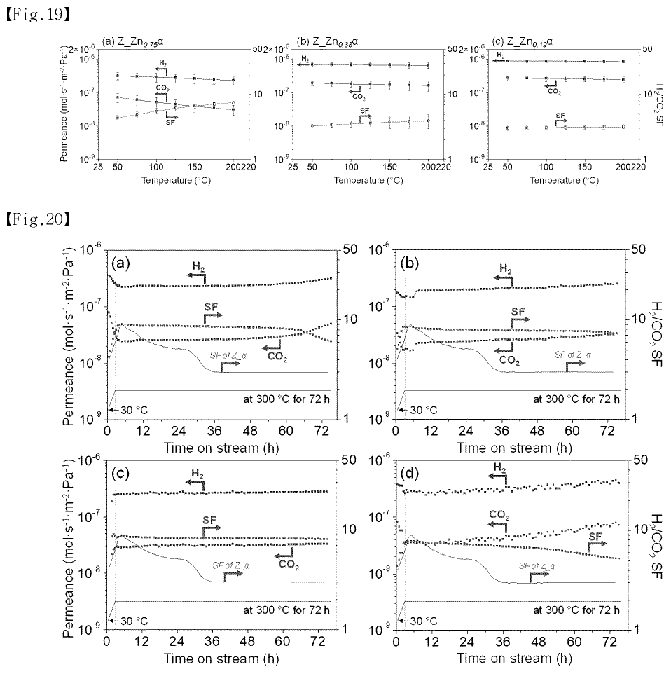

FIG. 19 shows the temperature-dependent H₂/CO₂ separation performance of (a) Z_Zn0.75α, (b) Z_Zn0.38α, and (c) Z_Zn0.19α according to an embodiment of the present invention.

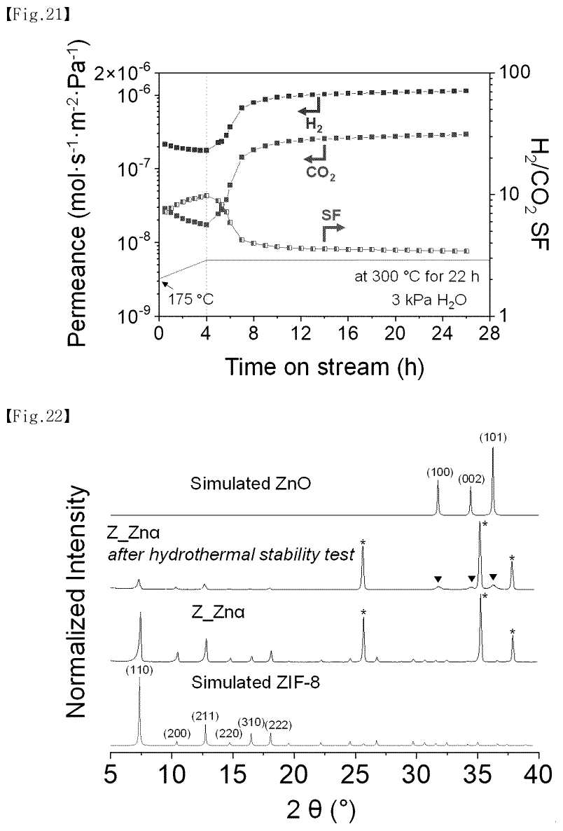

FIG. 20 shows the H₂/CO₂ separation performance of four independent Z_Znα membranes measured for up to 72 hours at 300° C. according to an embodiment of the present invention, the red line shows the temperature profile used in the separation performance test, and for fair comparison, the dark blue-green line of (a)-(d) shows the H₂/CO₂ SF of the ZIF-8 membrane prepared by the interdiffusion method in the previous study (i.e., Z_α based on the sample labeling used in the present invention) (E. Jang, E. Kim, H. Kim, T. Lee, H. J. Yeom, Y. W. Kim, J. Choi, J. Membr. Sci. 540 (2017) 430-439).

FIG. 21 is a graph showing the results of a long-term hydrothermal stability test of Z_Znα for equimolar wet H₂/CO₂ binary mixture feed at 300° C. for up to about 22 hours according to an embodiment of the present invention.

FIG. 22 shows XRD patterns of Z_Znα and Z_Znα after a hydrothermal stability test at 300° C. shown in FIG. 21, simulated XRD patterns of ZIF-8 and ZnO are shown at the bottom and top, respectively, and an asterisk (*) and an inverted triangle (V) show XRD peaks generated in a α-Al₂O₃ disk and zinc oxide, respectively.

1. Zn Source Deposition on Porous α-Al₂O₃ Supports

A modified CD method involving a coating process using a Zn source and a solvothermal reaction was used to prepare the ZIF-8 membrane. To form a separation membrane, 4.2 g of zinc acetate dihydrate (Zn(CH₃COO)₂·2H₂O, product number 383058, 98%, Sigma-Aldrich) was first dissolved in 40 mL of methanol (product number 179337, 99.8%, Sigma-Aldrich) to produce a high concentration Zn solution (0.48 M). For convenience, zinc acetate dihydrate is hereinafter referred to as ZA. In addition, a series of Zn solutions (0.09, 0.18 and 0.36 M) were prepared by proportionally reducing the amount of ZA. In a typical Zn source coating process, a directly prepared porous α-Al₂O₃ disk (diameter of about 21 mm, thickness of 2 mm) was immersed in the ZA solution for 3 hours with the polished surface facing upward. A detailed description of the polishing procedure will be omitted. The ZA-containing α-Al₂O₃ disk was then placed in a vacuum oven (OV-11, Jeio Tech Co.) to evaporate the methanol solvent. It was dried at 50° C. for 3 hours in Ltd. (Korea). The α-Al₂O₃ disks that were immersed and then dried in solutions with ZA concentrations of 0.48, 0.36, 0.18 and 0.09 M are designated Znα, Zn_{0.75}α, Zn_{0.38}a and Zn_{0.19}%, respectively, where a represents the α-Al₂O₃ disk and the numbers between Zn and a represent the molar concentrations for the saturated molar concentration of 0.48 M.

### 2. Synthesis of a ZIF-8 Film

To synthesize the ZIF-8 membrane, a ligand solution was used to induce crystallization and growth of ZIF-8 particles on a porous α-Al₂O₃ support. Briefly, 2.59 g of 2-methylimidazole (2-methylimidazole; product number M50850, 99%, Sigma-Aldrich) and 0.25 g of sodium formate (product number 247596, ≥99%, Sigma-Aldrich) were dissolved in 20 mL of methanol with vigorous stirring. The well-dissolved ligand solution was then transferred to a Teflon liner and the Znα support was placed horizontally in the 2-methylimidazole solution with the polishing surface up. This procedure used for Znα was equally applied to Zn_{0.75}α, Zn_{0.38}a and Zn_{0.19}α samples. The Teflon liner was sealed in a stainless steel autoclave and the solvothermal reaction was carried out under static conditions at about 120° C. for 4 hours. After the reaction, the autoclave was quenched with tap water to stop the formation of the membrane. The recovered samples were rinsed with fresh methanol and dried under atmospheric conditions for about 2 hours. Finally, the dried sample was further heat treated overnight at about 160° C. in a convection oven (PL_HV_250, Pluskolab, Korea) to remove methanol residue. For convenience, the resulting samples are denoted as Z_Znα, Z_Zn_{0.75}α, Z_Zn_{0.38}α, and Z_Zn_{0.19}a, where Z represents the ZIF-8 membrane synthesized from the corresponding Zn-containing samples (Znα, Zn_{0.75}α, Zn_{0.38}a and Zn_{0.19}α)

That is, in the present invention, a process of depositing and immobilizing a Zn precursor on the surface and inside of the porous support is performed before synthesizing the ZIF-8 membrane. Next, a ZIF-8 membrane is synthesized through an interdiffusion method using a support on which the Zn precursor is deposited and fixed. When the porous support on which the Zn precursor is deposited and fixed is immersed in the 2-methylimidazole solution, Zn²⁺ ions are diffused outward from the support side, and at the same time, the diffusion of 2-methylimidazole proceeds from the bulk solution side to the support side. At this time, since Zn²⁺ ions and 2-methylimidazole have high reactivity with each other, crystals are formed almost simultaneously with the contact, thereby synthesizing a ZIF-8 membrane.

In the conventional general ZIF-8 synthesis, since the Zn precursor is not deposited and immobilized on the surface and inside of the support, Zn²⁺ ions are rapidly diffused to the outside through the pores of the support and meet 2-methylimidazole to form most of the membrane on the upper portion of the support. In contrast, in the present invention, the Zn precursor is deposited and immobilized on the surface and inside of the support, and then a ZIF-8 separation membrane is synthesized, so that a separation membrane is also formed inside the support.

Therefore, in the present disclosure, since the ZIF-8 membrane is positioned inside the porous support, the stability of the membrane against physical factors such as external impact may be increased. In addition, the existing ZIF-8 membrane directly contacts high-temperature H₂ and CO₂ gases to show low thermal stability and long-term stability. In contrast, in the case of the ZIF-8 membrane according to the present invention synthesized after depositing and immobilizing the Zn precursor on the surface and inside of the support, the membrane is formed inside the support and is not directly exposed to a high temperature gas, so that it may have higher thermal stability and long-term stability than the existing ZIF-8 membrane.

3. Measurement of H₂/CO₂ Separation Performance

The H₂/CO₂ separation performance of the ZIF-8 membrane in the custom-made permeation cell was evaluated by using the Wickke-Kalenbach method, and the total pressure of the feed and permeate sides was maintained at about 101 kPa. The separation performance of the membrane was investigated as a function of temperature using an oven (DX330, Yamato Scientific Co., Ltd., Japan). For reliability, a heat resistant Kalrez O-ring was used for the membrane seal during the separation measurements according to temperature up to 300° C., while a Viton O-ring was used for the measurement up to 200° C. In addition, the flow rate of equimolar H₂/CO₂ binary mixture supply was about 100 mL·min-1, whereas a helium flow rate of about 100 mL·min-1 was used at the permeate side to carry the permeate component for gas chromatography (GC); YL 6500, Young In Chromass, Korea) analysis. The molar composition of the permeate stream was analyzed using a pulsed discharge ionization detector (PDD). In addition, 5 mL·min-1 of CH₄ was added as an internal standard prior to the GC measurement in order to stably estimate the molar flux of the permeate component.

### 4. Characterization

The film shape and element distribution were analyzed using a field-emission scanning electron microscope (FE-SEM, S-4800, Hitachi Ltd, Japan) equipped with an energy dispersive X-ray spectrometer (energy-dispersive X-ray spectroscopy; EDX). X-ray diffraction (XRD) characterization was performed using a D/Max-2500V/PC X-ray diffractometer (Rigaku Co., Japan) with Cu-Kα radiation (λ=0.154 nm) generated at 40 kV and 100 mA in the range of 5°-40°. For reference, the crystallographic information files for ZIF-8 (deposit no. 602542) and ZnO are respectively Cambridge Crystallographic Data Center (CCDC, www.ccdc.cam.ac.obtained from uk) and Materials Studio 7.0 (Accelrys, USA). The corresponding simulated XRD patterns were obtained using Mercury software available at wmww.ccdc.cam.ac.uk. In addition, N2 adsorption isotherms were obtained at 77K using an ASAP 2020 instrument (Micromeritics Instruments Corporation, USA). Prior to measuring the N2 adsorption isotherms, α-Al₂O₃ disks, Znα and Z_Znα samples were degassed for 24 hours at 350, 80 and 200° C., respectively. The specific surface area was estimated by the Brunauer-Emmett-Teller (BET) method, and the micropores and the external surface area were calculated by the t-plot method. Finally, an automatic mercury porosimeter was used to analyze the pore size distribution and porosities of the α-Al₂O₃ disk and the ZIF-8 membrane (Autopore IV 9520, Micromeritics Instruments Corporation, USA).

5. Structural Properties of ZIF-8 Membrane Synthesized by Plugging Grains Inside α-Al₂O₃ Disk

The planar SEM image of FIG. 1a shows that the porous α-Al₂O₃ support is completely covered with ZIF-8 grains, forming a continuous ZIF-8 layer on the top surface. In addition, the enlarged region of the top layer of FIG. 1b shows that some ZIF-8 particles were randomly stacked to form a rough microstructure on top of the continuous ZIF-8 membrane. In addition, the cross-sectional SEM image supported the continuity of the α membrane at the top surface, although it was difficult to clearly determine the membrane particles inside the porous ZIF-8-Al₂O₃ support (FIG. 1c). To further confirm the location of the ZIF-8 membrane particles, EDX measurements were used to characterize the Zn element distribution.

The XRD analysis shown in FIGS. 10 and 11 shows that the modified CD method successfully grew a ZA containing support (i.e., Znα) into a ZIF-8 membrane (i.e., Z_Znα).

First, elemental line scanning provided significant Zn signals in the top continuous membrane, but relatively weak signals deep inside the support (FIG. 1c). For more reliable measurements, EDX line scanning was performed at additional sites and Zn greater than 30 μm along the support thickness was shown to be significantly present (FIG. 12). In addition, element mapping was performed over a wide range of scales to determine the possible positions of the synthesized ZIF-8 membrane particles. As shown in FIGS. 1d-f, the EDX mapping image clearly shows the presence of subsurface components that form the Z_Znα membrane. Specifically, the ZIF-8 film particles were densely formed to a depth of about 80 μm. Interestingly, the surface particles are non-homogeneous and discontinuous but highly dispersed at EDX resolution. This embedded configuration was consistent with the hypothesis that the use of a captured Zn source would promote dense growth of ZIF-8 particles while filling or blocking pores inside the porous support.

A series of ZIF-8 membranes were then prepared by reducing the concentration of the ZA solution from a saturation value of 0.48 M to 0.36, 0.18 or 0.09 M. This was done to gain insight into the effect of ZA concentration on the structural properties of the final membrane. All ZA-containing α-Al₂O₃ supports showed similar XRD patterns consistent with standard anhydrous zinc acetate, demonstrating successful formation of Zn source coated composite structures (FIG. 10). However, as the ZA concentration decreased, the loading of the porous support decreased proportionally (Table 1). This trend was also consistent with the decrease in XRD peak intensity in the order of Znα to Zn0.19α (FIG. 10). Additional information was obtained from the SEM images of all ZA-containing supports (FIGS. 2a-c and 13). Among the prepared ZA-containing supports, Znα showed unique characteristics in that bulk ZA was attached to the surface (FIGS. 2a and 2c), whereas the Zn precursor was likely to completely fill the gaps or pores between the α-Al₂O₃ grains (as shown in FIG. 2b, it showed an apparently stained appearance). In contrast, the low concentration counterparts (i.e., Zn_{0.75}α, Zn_{0.38}a and Zn_{0.19}a) did not contain detectable Zn sources on the top surface of the support (FIG. 13). Despite the significant difference in the amount of loaded ZA, the ligand induced solvothermal reaction still resulted in the formation of ZIF-8 films from all ZA containing supports (FIG. 3a). In particular, the monotonically decreasing XRD peak intensity from Z_Znα to Z_Zn_{0.19}α was consistent with the decreased ZIF-8 content in the membrane (Table 1). Compared to the Z_Znα shown in FIG. 1, Z_Znxα (x=0.75, 0.38, 0.19) showed a loose structure (FIG. 14). Specifically, these films consisted of irregularly stacked ZIF-8 particles, and lacked a continuous and well-grown microstructure.

In addition, the relationship between the Zn precursor weight and the resulting ZIF-8 film weight was explored to explain the role of Zn precursor loading on film formation and properties. As previously reported, the theoretical weight of the Zn source and the ZIF-8 particles inside the porous support can be calculated assuming that the pores of the α-Al₂O₃ disk (estimated by the porosity in Table 2) in the used methanol solution were occupied by all ZA, and the occupied ZA was completely converted to ZIF-8 (D. J. Babu, G. W. He, J. Hao, M. T. Vandat, P. A. Schouwink, M. Mensi, K. V. Agrawal, Adv. Mater. 31 (2019) 1900855). First, it was confirmed that the theoretical ZA weights calculated for Znα and Znxa (x=0.75, 0.38, 0.19) monotonously increased as the ZA concentration increased (FIG. 3B). At the same time, the change in weight of the ZA-containing disks before and after the solvothermal reaction was tracked (Table 1). Experimentally measured ZA weights at Znα and Znxa (x=0.75, 0.38, 0.19) over the entire range of ZA concentrations were slightly higher than the theoretical weights, but both showed similar and steadily increasing trends as a function of ZA concentration. Second, the measured weights of prepared ZIF-8 membranes (i.e., Z_Znα and Z_Znxα (x=0.75, 0.38, 0.19) followed a similar trend. However, it was clear that Z_Znα and Z_Zn0.75α contained lower amounts of ZIF-8 than theoretical values. The nominal molar ratio of Zn (used to prepare Znα) to 2-methylimidazole for the solvothermal reaction to form Z_Znα was 1/8, but the actual molar ratio based on the precipitation weight of Zn (Table 1) was estimated to be 1/100 for Z_Znα. This indicates that the buried Zn source can be easily converted into the crystalline ZIF-8 phase. Thus, a slight leaching of the Zn source may have an impact on the low ZIF-8 film weight as compared to theoretical predictions. Nevertheless, comparable experimental and theoretical ZIF-8 membrane weights as a function of ZA concentration supported the formation of crystalline solids on and in the porous support.

In addition, the correlation between the membrane structure and the separation performance was investigated. To this end, equimolar H₂/CO₂ separation performance of Z_Znα and Z_Znxα (x=0.19, 0.38, 0.75) was considered at an industrially relevant temperature of 200° C. As shown in FIG. 3B, a proportional increase in the amount of ZIF-8 according to an increase in ZA concentration was effective in improving the H₂/CO₂ separation performance. Indeed, the Z_Znα membrane containing the highest ZIF-8 content, which appears to be due to the limited solubility of ZA, showed optimal H₂/CO₂ separation performance with a corresponding H₂/CO₂ SEPARATION PERFORMANCE of about 8.5. This may be due to the fact that the higher ZIF-8 content may span a large separation area, thus enhancing the intrinsic molecular sieving favorable to H₂ transport.

Then, the micropore structures of the α-Al₂O₃ disk, Znα, and Z_Znα samples were analyzed to obtain more detailed microstructural properties. The N2 physisorption isotherm at 77 K (FIG. 3C) showed a very small amount of micropores in the α-Al₂O₃ disk with a unimodal macro pore distribution around about 157 nm (FIG. 3D). As the non-porous solid ZA was previously deposited on the support and integrated into the macropores, the resulting Znα exhibited a lower gas absorption capacity than α-Al₂O₃ disc in the entire pressure range (FIG. 3c). When converting solid ZA to ZIF-8, the buried ZIF-8 particles produced significant micropores that were reflected by the enhanced gas absorption capacity (FIG. 3C). In addition, in FIG. 3c, for N2 physisorption comparison, a ZIF-8 film (in the present invention, this film is called Z a so as to match the sample label) synthesized using the conventional CD method without the Zn source pretreatment step was adopted. As shown in FIGS. 3c and d, the Z_Znα samples showed much higher N2 uptake capacity and significantly reduced pore diameter than the Z a in which the ZIF-8 membrane particles were mainly formed on the α-Al₂O₃ disk. Quantitatively, Z_Znα obtained a weight of almost twice that of Z_α in both micropore-based estimated and actual weights (Table 3). This means that by pre-depositing the Zn source on the surface and inside of the porous support, minor modifications of conventional CD methods have facilitated the formation of high content of buried ZIF-8 particles.

Table 1 shows the measured weights of ZA and generated ZIF-8 loaded for Z_Znα and Z_Znxα (x=0.75, 0.38 and 0.19) as a function of ZA concentration.

Table 2 shows the Textural properties of the α-Al₂O₃ disk, Znα and Z_Znα samples, along with the weight of ZIF-8 particles synthesized in the methanol medium and Z_α as reference.

Table 3 shows the estimated and measured weight of Z_Znα, and the expected weight of Z a was calculated based on the micropore surface area.

TABLE 1

| | Measured Weight | Measured Weight of |
|---|---|---|
| Sample label | of Loaded ZA | ZIF-8 Produced |
| (ZA molar concentrations) | (mg · g−1a)Note1) | (mg · g−1)Note 1) |
| Z_Zn0.19α | 4.4 ± 0 | 6.7 ± 0.2 |
| (0.09 M) | | |
| Z_Zn0.38α | 6.7 ± 0.9 | 8.7 ± 0.4 |
| (0.18 M) | | |
| Z_Zn0.75α | 15.1 ± 0.6 | 10.7 ± 1.3 |
| (0.36 M) | | |
| Z_Zna | 34.3 ± 16.9 | 13.6 ± 0.9 |
| (0.48 M) | | |

Note 1)
The net weight was obtained by subtracting the weight of bare a- Al₂O₃ disks from the final weight after ZA loading or ZIF-8 formation.

TABLE 2

| | BET | Micropore | External | |
|---|---|---|---|---|
| | Surface | Surface | Surface | |
| | area | Area 1) | Area 2) | Porosity |
| Samples | (m2 · g−1) | (m2 · g−1) | (m2 · g−1) | (%) |
| α-Al₂O₃ disc | 3.9 ± 0.0 | 0.04 | 3.8 | 40.3 |
| Znα | 2.7 ± 0.0 | 0.45 | 2.2 | N/A |
| Z_Znα | 20.2 ± 0.2 | 16 | 4.2 | N/A |
| ZIF-8 Particle | 1640 ± 10 | 1577 | 65 | N/A |
| Note 3) | | | | |
| Z_α Note 4) | 10.1 ± 0.0 | 7.9 | 2.1 | N/A |

Note 1)
Estimated using the t-plot method.
Note 2)
Calculated by subtracting the micropore surface area from the total BET surface area.
Note 3)
The texture properties of ZIF-8 particles synthesized in methanol media were adopted in previous studies. (T. Lee, H. Kim, W. Cho, D. Y. Han, M. Ridwan, C. W. Yoon, J. S. Lee, N. Choi, K. S. Ha, A. C. K. Yip, J. Choi, J. Phys. Chem. C 119 (2015) 8226-8237)
Note 4)
The texture properties of ZIF-8 membranes produced by conventional despreading methods were adopted in previous studies. (E. Jang, E. Kim, H. Kim, T. Lee, H. J. Yeom, Y. W. Kim, J. Choi, J. Membr. Sci. 540 (2017) 430-439)

In Table 2, the surface area of the Znα on which the Zn precursor is deposited and immobilized is reduced compared to the existing α-Al₂O₃ disk. Thereafter, Z_Znα synthesized by solvothermal reaction of Znα has an increased surface area since ZIF-8 membranes having micropores are formed on the outside and inside of the disk support. As a result of the previous study, Z_α showed that since the ZIF-8 membrane was mainly present only outside the disk support, the surface area of Z_Znα in which the ZIF-8 membrane was present was much larger even outside and inside the disk support.

TABLE 3

| | Estimated Weight Based on Micropore | Actual |
|---|---|---|
| samples | Surface Area (mg) Note 2) | weight |
| Z_Znα | 16.4 | 19.4 ± 2.1 |
| Z_α Note 1) | 8.0 | 11.0 ± 0.1 |

Note 1)
Methods reported previously (E. Jang, E. Kim, H. Kim, T. Lee, H. J. Yeom,Y. W. Kim, J. Choi, J. Membr. Sci. Z_α synthesized as 540 (2017) 430-439.
Note 2)
Obtained by applying the t-plot method to the N2 adsorption isotherm shown in FIG. 3c.

### 6. Effect of Zn Precursor Position on ZIF-8 Membrane Performance

FIG. 3b demonstrates the superiority of Znα in the construction of H₂ permselective ZIF-8 films. Znα appears to contain two regions of ZA pre-deposition. The bulk ZA particles were attached to the outer surface, while the Zn source filled the pores of the support (FIGS. 2a-c). To understand the effect of Zn precursor position on film formation and properties, two controllable means for treating Znα prior to the solvothermal reaction were designed. In one method, Znα was immersed in methanol for a period of time to remove the Zn source contained inside the α-Al₂O₃ disk. For convenience, the treated Znα sample is referred to as Ix-Znα, where I represents immersion in methanol and x represents the immersion time (min). In another method, the top surface of Znα was mechanically polished with sandpaper to remove the attached bulk ZA particles. Similarly, the polished Znα sample is referred to as Gx-Znα, where the letters G and x represent the number of grinding processes and surface polishing steps, respectively.

FIG. 2D and FIG. 2E respectively show planar SEM images of a Znα sample (i.e., 110-Znα) immersed in methanol for 10 minutes and a Znα sample (i.e., G80-Znα) mechanically polished 80 times. After immersing in methanol for 10 minutes, the ZA pre-deposited in the pores of the α-Al₂O₃ particles was partially dissolved, while the bulk ZA particles were still present on the top surface of the I10-Znα (FIG. 2d). The ZA loading after immersion decreased by about 54%. On the other hand, the surface polishing of Znα (80 times) effectively removed the bulk ZA particles on the surface, resulting in a scratch surface although the surface was smoother than that of the existing Znα sample (FIG. 2e). Nevertheless, the pores inside the α-Al₂O₃ support still appear to be filled by ZA deposits, with the amount estimated to be 44% of the ZA loading.

For better understanding, a schematic view of each immersion and surface polishing process is shown in FIG. 4. Coincidentally, the I10-Znα and G80-Znα samples had nearly identical amounts of the remaining ZA, with the most important difference being the different positions of the ZA precipitate. After the solvothermal reaction, the H₂/CO₂ separation performance was tested at 200° C. using the corresponding membranes (i.e., Z_I10-Znα and Z_G80-Znα) (FIG. 2f). The Z_I10-Znα membrane showed H₂/CO₂ separation performance comparable to the Z_Znα standard, which was synthesized from intact Znα (H₂/CO₂ separation performance of 8.5 for Z_Znα vs. 7.9 for Z_I10-Znα) and H₂ permeability (1.2×10⁻⁷ Z_Zn for αmol·s¹·m⁻². Pa⁻¹ vs. 1.6×10⁻⁷ Z_I10-Zn for αmol s⁻¹·m⁻²·Pa⁻¹). In comparison, the Z_G80-Znα membrane had much lower separation performance, and the H₂/CO₂ SF was significantly reduced to about 3.1. Regardless of the amount of ZA loading decreasing in both I10-Znα and G80-Znα membranes, unlike the initial guess, the attached bulk ZA particles played an important role in the formation of high performance membranes.

To dissolve and remove the buried ZA precipitate, the immersion time of Znα in methanol was further extended to 10 to 30 min or 60 min. The resulting 130-Znα and I60-Znα samples showed attenuated XRD peak intensities, indicating a significant reduction in the amount of ZA (FIG. 15A). Indeed, prolonged methanol immersion resulted in removal of large bulk ZA particles from the outer surface (FIGS. 16a and 16b). Specifically, the ZA contents of 130-Znα and 160-Znα decreased by about 91% and 98%, respectively. Despite the significant decrease in the amount of ZA at I10-Znα, the film form of Z_I10-Znα (FIG. 17a), which appeared to be well crossed between the particles, was similar to the Z_Znα sample (FIG. 1b), which had good performance. However, the Z_I30-Znα membrane showed a distinct shape. A loose layer having poorly defined polycrystalline properties was observed (FIG. 17B). In addition, it seems that the Zn source of I60-Znα was insufficient, and thus a film structure recognizable in the resulting Z_I60-Znα sample was not formed (FIG. 17C). In particular, both Z_I30-Znα and Z_I60-Znα showed H₂/CO₂ SF of 5.9 and 4.0 at 200° C., respectively, and still showed appropriate H₂/CO₂ separation capability (FIG. 17d). The number of surface polishing steps also determined the amount of residual ZA in Gx-Znα. A smaller number of surface polishing steps (40 times) were also used to determine the effect of the Zn source location (FIG. 16c) on the membrane formation and separation properties. The residual ZA amount of Gx-Znα (x=40 and 80) is likely lower than the residual ZA amount of Znα (FIG. 15B). In addition, the resulting ZIF-8 membrane appears to exhibit better internal growth microstructure at SEM resolution than that made with the counterparts (FIGS. 17a-c) immersed in methanol (FIGS. 18a and 18b). Despite the strong and similar dissolution of the Zn source obtained by methanol immersion, the mechanical polishing did not entail a loss of buried Zn source as reflected by the much higher amount of residual ZA in G40-Znα (76%) and G80-Znα (44%) (FIG. 18C). Nevertheless, the apparently well-constructed segregation layer in G40-Znα and G80-Znα does not provide the desired H₂/CO₂ segregation capability, resulting in a H₂/CO₂ separation performance of about 3.1-3.8 (FIG. 18C). Thus, instead of loading, it is clear that the Zn source location played an important role in determining the ZIF-8 membrane formation and H₂/CO₂ separation performance. In addition, it is speculated that the ZA particles on the top of the support induce the primary formation of a continuous ZIF-8 layer on the top of the support serving as a barrier, thereby suppressing diffusion of the Zn precursor into the bulk solution inside the support. This will promote the growth of a dense ZIF-8 layer inside the support for interlocking membrane construction.

7. It Relates to the H₂/CO₂ Separation Performance and Thermal/Mechanical Stability of a ZIF-8 Membrane

Next, the temperature-dependent H₂/CO₂ separation performance of the ZIF-8 membrane for equimolar H₂/CO₂ mixtures was investigated over a wide temperature range (30-200° C., FIG. 5A). For reliability, three independent Z_Znα membranes were used (FIG. 5A). The performance is described by means and error bars (standard deviation values). In particular, the Z_Znα membrane was found to have a monotonic decrease in both H₂ and CO₂ permeability as the temperature increased. From a molecular point of view, the CO₂ molecule is more polar than the H₂ molecule and thus appears to have a desirable adsorption capacity and higher transportability at relatively low temperatures. However, the elevated temperature significantly suppressed the adsorption capacity of CO₂, thus inhibiting preferential transport. As a result, the permeability of CO₂ decreased much faster than that of H₂ as the temperature increased. Thus, this contributed to the gradual increase in H₂/CO₂ SF as the temperature increased. In addition to the Z_Znα membrane performing well, Z_Zn_{0.75}α samples showed improved H₂/CO₂ separation performance at high temperatures, while other Z_Zn_{0.38}a and Z_Zn_{0.19}α samples had low continuity at SEM resolution (FIGS. 14b1 and 14cl) and did not show the desired H₂/CO₂ separation capability (FIG. 19). Importantly, the improved separation performance of Z_Znα at high temperatures is advantageous for industry-related applications. In general, since the WGS reaction is performed in a high operating temperature range of 200 to 360° C., an integrated membrane module capable of maintaining excellent separation performance at a temperature of 200° C. or higher is required. However, the thermal sensitivity of conventional polycrystalline ZIF-8 membranes has been reported in previous studies. Specifically, a well intergrown polycrystalline ZIF-8 membrane with a top layer of 3 μm thickness experienced severe ZIF-8 structural degradation (reduced crystallinity) at 150° C. and appeared to crack when the operating temperature was 300° C. In particular, an unstable ZIF-8 bond associated with a difference in the thermal expansion coefficient between ZIF-8 and the ceramic support and partial carbonization of the Zn—N framework at a high temperature may cause defect generation and deterioration in the crystallinity of ZIF-8. Therefore, in order to evaluate the potential of Z_Znα as a membrane reactor requiring strong H₂/CO₂ separation performance, the separation measurement temperature was expanded to 300° C., which can be called a representative WGS reaction temperature. Unlike the cold zone, the H₂ permeability of the Z_Znα membrane (this sample was not used in FIG. 5a for clarity) was independent of temperature, whereas the CO₂ permeability decreased slightly as the temperature increased from 200 to 300° C. (FIG. 5b). Specifically, the Z_Znα membrane showed excellent H₂/CO₂ separation performance with H₂ permeability of 1.3×10⁻⁷ mol m⁻² s⁻¹ Pa⁻¹ and H₂/CO₂ SF of 8.7 at 300° C.

Instead of forming an existing well-intergrown separation layer or membrane on top of the porous support, embedding, more precisely plugging, the ZIF-8 particles inside the support was strategically effective to minimize the aforementioned thermally induced ZIF-8 structural damage while maintaining the integrity of the original ZIF-8. In addition, the mechanical stability of Z_Znα was examined by mechanically polishing or polishing the continuous separation layer formed on the upper surface. This allowed us to determine the role of surface interlocking and dense ZIF-8 particles in the separation of H₂/CO₂ at high temperature. For convenience, the polished Z_Znα membrane is referred to as Z_Znα-Gx, where x represents the number of mechanical polishing steps. In particular, the mechanical polishing of the ZIF-8 membrane did not impair the H₂/CO₂ separation performance, and the membrane maintained a H₂/CO₂ separation ability that steadily improved as the temperature increased. More surprisingly, both intact Z_Znα and Z_Znα-G100 membranes have similar H₂/CO₂ SF (e.g., 7.5 for Z_Znα-G100 versus 7.7 for Z_Znα at 200° C.) and H₂ permeability (e.g., 1.6×10⁻⁷ mol··s⁻¹ m⁻²·Pa⁻¹ at 200° C. versus 1.3×10⁻⁷ mol·s⁻¹ m⁻²·Pa⁻¹ for Z_Znα-G100). Thus, the well-preserved gas separation capacity of Z_Znα-G100 provided further evidence for the critical and positive contribution of the buried or plugged interlocking membrane particles of H₂/CO₂ inside the α-Al₂O₃ disk to the robustness of the high temperature Z_Zn α separation capacity.

In a previous study (D. J. Babu, G. W. He, J. Hao, M. T. Vandat, P. A. Schouwink, M. Mensi, K. V. Agrawal, Adv. Mater. 31 (2019) 1900855), the γ-Al₂O₃ layer with a smaller pore size (about 5 nm) served as a diffusion barrier to limit the growth of ZIF-8 particles inside the α-Al₂O₃ disk in the conventional CD scheme. Compared to the composite membrane structure revealed by the SEM and EDX results in FIGS. 1c-f, the ZIF-8 membrane of the previous study consisted mainly of a large number of buried γ particles without a continuous layer on top of the ZIF-8-Al₂O₃ layer.

Although the buried separation layer provided mechanical stability, the ZIF-8 crystalline membrane (this ZIF-8 membrane is referred to as Z_γα to match the sample labeling in the present invention) still underwent thermally induced separation after about 10 consecutive hours of separation at 300° C.

In view of this structural discrepancy, the long-term thermal stability of the Z_Znα membrane in the present invention was further evaluated in relation to the H₂/CO₂ separation performance.

In particular, long-term stability is a prerequisite for implementing an integrated WGS membrane reactor. FIG. 5D shows the H₂/CO₂ separation performance of the Z_Znα membrane over time at 300° C. During heating from 30 to 300° C., the transmittance of CO₂ decreases much faster than H₂, resulting in a monotonous increase in H₂/CO₂ SF and a final separation performance of 8.7 at 300° C. In particular, as a result of measurement at 300° C. for 72 hours, the Z_Znα membrane showed stable permeation behavior without significant separation loss. For better comparison, the H₂/CO₂ SF of the Z_α membrane made using the existing CD strategy is shown in FIG. 5d to serve as a reference. Obviously, the H₂/CO₂ separation performance of the existing Z_α membrane was significantly degraded after 2 hours of heat treatment, which seems to be due to a marked structural degradation. To strictly evaluate thermal stability at 300° C., four additional Z_Znα membranes fabricated using the same synthetic procedure were tested according to the temperature protocol depicted in FIG. 5d (FIG. 20). All of the prepared Z_Znα membranes showed stable and similar H₂/CO₂ separation performance over time (FIGS. 5d and 20), suggesting that the methodology of the present invention for ZIF-8 membrane preparation is appropriate. This high long-term stability successfully demonstrated the excellent thermal durability of the embedded or plugged ZIF-8 membrane configurations prepared in the present invention.

Initially, ZIF-8 crystals have been reported to have abnormal thermal stability under inert gas flow. However, the ZIF-8 framework is susceptible to accelerated carbonization or local pyrolysis in an oxidizing or reducing atmosphere. As a result, the high sensitivity to temperature and the environment reduced the application of ZIF-8 membranes under industrially relevant conditions. However, unlike the conventional ZIF-8 framework collapsed due to heat treatment, the structure of ZIF-8 was maintained for the Z_Znα film after treatment at 300° C. for 72 hours, as shown in FIG. 6. It is estimated that the ZIF-8 particles embedded in the Z_ZnAl₂O₃ membrane, which effectively blocked the pores of the α-α disk with a thickness of 80 μm (FIG. 1f), resists pyrolysis. That is, even if the upper and lower regions of the ZIF-8 particles inside the α-Al₂O₃ disk are damaged after high temperature exposure, the unique interlocking microstructure of the α particles that blocks through the pores of the ZIF-8-Al₂O₃ disk improved the thermal stability of the Z_Znα membrane to a significant thickness of about 80 μm. A major differentiator from the prior art is that the Z_Znα membrane formed a dense pore blocking structure of ZIF-8 particles at a thick penetration depth (about 80 μm).

In a typical WGS reaction, the vapor is high in volume and coexists with the H₂/CO₂ product stream. The ZIF-8 framework has been reported to be vulnerable to hydrothermal conditions because water molecules that can serve as proton donors separate Zn—N bonds. Therefore, the wet H₂/CO₂ separation performance of the Z_Znα membrane was further evaluated as a function of temperature. For reliability, another Z_Znα membrane sample (not used in FIG. 5a) was tested for both dry and wet H₂/CO₂ separation (FIG. 7). As shown in FIG. 5A, the Z_Znα membrane showed a decrease in H₂ and CO₂ permeability at a high temperature for a dry H₂/CO₂ mixture having a higher degree of decrease in CO₂ molecules, and the H₂/CO₂ SF was steadily improved (FIG. 7A). However, the introduction of 3 mol % water vapor into the membrane sample resulted in loss of the original H₂ selective permeability capacity (5.5 at 30° C. under dry conditions versus 0.5 under wet conditions) and a significant decrease in H₂ and CO₂ permeability (FIG. 7b).

ZIF-8 is known to be hydrophobic, but it showed moderate water vapor adsorption capacity. However, at an operating temperature of 100° C. or higher, since the effect of water vapor adsorption was alleviated, the diffusion of H₂ and CO₂ through the ZIF-8 membrane was easy (FIG. 7B). Thus, Z_Znα membranes showed similar H₂/CO₂ SF (10.7 at 200° C. under dry conditions versus 7.2 under wet conditions) and H₂ permeability (8.6×10⁻⁸ mol·m⁻²·s⁻¹·Pa⁻¹ at 200° C. under dry conditions versus 2.3×10⁻⁷ mol·m⁻²·s⁻¹·Pa⁻¹ under wet conditions). In addition, the hydrothermal stability of the Z_Znα membrane was measured in 3 mol % water vapor at a representative WGS reaction temperature of 300° C. As shown in FIG. 21, another Z_Znα membrane showed improved H₂/CO₂ SF during the initial heat rise. The Z_Znα membrane achieved optimal H₂/CO₂ separation performance (H₂/CO₂ SF of about 9.8 and H₂ permeability of 1.8×10⁻⁷ mol·m⁻²·s⁻¹·Pa⁻¹) as soon as the temperature reached the target value of 300° C. Unfortunately, the Z_Znα membrane did not retain the desired H₂/CO₂ separation capability after 3 hours, and subsequent XRD analysis showed that degraded H₂/CO₂ separation performance was associated with the structural degradation of the Z_Znα membrane in the presence of high temperature steam (FIG. 22). It has been reported that hydrothermal conditions can activate acid catalytic hydrolysis reactions in the ZIF framework via slightly acidic α-Al₂O₃ support, resulting in structural degradation to zinc oxide. Thus, the use of neutral supports such as SiO2 could potentially eliminate these acid catalytic effects. Grafting highly hydrophobic functional groups into the ZIF-8 framework is an alternative strategy to improve hydrothermal stability.

In FIG. 8, the H₂/CO₂ separation performance of the Z_Znα membrane was compared with the separation performance of other ZIF-8 membranes reported in the literature (Y). Li et al., J. Membr. Sci., 2010, 354, 48-54; Y.-S. Li et al., Adv. Mater., 2010, 22, 3322-3326; Y.-S. Li et al., Angew. Chem. Int. Ed., 2010, 49, 548-551; V. M. Aceituno Melgar et al., J. Membr. Sci., 2014, 459, 190-196; S.-J. Noh et al., J. Nanosci. Nanotechnol., 2015, 15, 575-578; K. Huang et al., Chem. Commun., 2013, 49, 10326-10328; Q. Liu et al., J. Am. Chem. Soc., 2013, 135, 17679-17682; G. Xu et al., J. Membr. Sci., 2011, 385-386, 187-193; Y. Zhu et al., Sep. Purif. Technol., 2015, 146, 68-74; A. Huang et al., Angew. Chem. Int. Ed., 2010, 49, 4958-4961; X. Dong et al., J. Mater. Chem., 2012, 22, 19222-19227; A. Huang et al., Angew. Chem. Int. Ed., 2011, 50, 4979-4982; A. Huang et al., J. Am. Chem. Soc., 2010, 132, 15562-15564; A. Huang, N. Wang, C. Kong, J. Caro, Angew. Chem. Int. Ed., 2012, 51, 10551-10555; A. Huang et al., Chem. Commun., 2012, 48, 10981-10983; H. Bux et al., Chem. Mater., 2011, 23, 2262-2269; L. Fan et al., J. Mater. Chem., 2012, 22, 25272-25276).

Although higher operating temperatures are preferred for H₂/CO₂ separation, most ZIF-8 membranes in the literature were tested in relatively moderate temperature ranges below 150° C. The low thermal stability of the previously mentioned conventional polycrystalline ZIF-8 membrane hinders practical use under industrially relevant conditions. In fact, a polymer membrane having high processability and low manufacturing cost is a competitive candidate for H₂/CO₂ separation in a low-temperature region. Compared to other ZIF-8 membranes, the Z_Znα in the present invention exhibited a significant H₂/CO₂ SF at a high temperature of 300° C. More importantly, the Z_Znα membrane exhibited and maintained significant H₂/CO₂ SF for up to 72 hours continuous measurement with an H₂/CO₂ SF of about 8.0 at a WGS reaction temperature of 300° C. The Z_Znα in the present invention showed the highest hydrothermal stability against H₂/CO₂ SF among the ZIF films reported so far (FIGS. 8 and 9).

Finally, in FIG. 9, a Zeolitic Imidazolate Frameworks (ZIFs) part is formed on the surface and inside of the porous support (α-Al₂O₃ disk) (see an enlarged view of the lower end of FIG. 9), and a first ZIFs part (1st ZIFs) is formed on the surface of the porous support (α-Al₂O₃ disk), and a second ZIFs part (2nd ZIFs) is buried inside the porous support (α-Al₂O₃ disk). In this case, the second ZIFs unit 2nd ZIFs may be formed in a state of being penetrated from an interface between the first ZIFs unit 1st ZIFs and the second ZIFs unit 2nd ZIFs by a predetermined depth.

Preferably, the first ZIFs portion (1st ZIFs) may have 0.1 μm to 10 μm, 1 μm to 5 μm, preferably 2 μm to 4 μm, and more preferably 3 μm. At this time, even if the surface of the first ZIFs part (1st ZIFs) formed on the upper portion of the porous support (α-Al₂O₃ disk) is polished, sufficient separation performance can be maintained thanks to the second ZIFs part (2nd ZIFs) inside the porous support.

In addition, the second ZIFs portion 2 nd ZIFs may be formed to penetrate from the interface between the first ZIFs portion 1 st ZIFs and the second ZIFs portion 2 nd ZIFs to a depth of 10 μm to 500 μm, 50 μm to 200 μm, preferably 70 μm to 150 μm, and more preferably 80 μm.

As described above, since the second ZIFs unit (2nd ZIFs) are formed to penetrate into the porous support to a predetermined depth, high thermal stability of the membrane may be secured.

### 8. CONCLUSION

Zinc acetate, which is used in the present invention as a metal source for ZIF-8 formation, was intentionally pre-deposited and immobilized on a porous α-Al₂O₃ disk to mitigate diffusion into the bulk solution during the CD method. In particular, the pre-deposited Zn source was important for growing ZIF-8 particles that block the pores of the α-Al₂O₃ disk. This manufacturing concept results in embedded membrane grains to constitute a continuous membrane construction. The resulting ZIF-8 membrane exhibited a maximum H₂/CO₂ separation performance of about 8.7 at a WGS reaction temperature of 300° C. Interestingly, H₂/CO₂ separation performance was almost proportional to the amount of buried ZIF-8 particles. These results show that the pre-deposition of the Zn source controls the membrane structure to control the separation performance. The buried ZIF-8 layer also improved the mechanical and thermal resistance of the membrane. More importantly, the ZIF-8 membrane particles embedded deep inside the α-Al₂O₃ disk formed a membrane structure about 80 μm thick, and surprisingly resisted the harsh high temperature H₂/CO₂ stream. Specifically, the well-constructed ZIF-8 membrane achieved stable H₂/CO₂ separation performance at a WGS reaction temperature of 300° C. for up to 72 hours, while the ZIF-8 membrane prepared using the conventional CD method failed. Nevertheless, the inflow of water vapor significantly damaged the ZIF-8 membrane particles after 3 hours at 300° C., indicating the need for additional strategies for water-resistant ZIF-8 particle formation. The present invention demonstrates an easy strategy for enhancing membrane thermal durability and emphasizes the potential of ZIF-8 membranes as membranes or membrane reactor walls for hot streams.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

1. A porous membrane comprising: a first Zeolitic Imidazolate Fragments (ZIFs) part formed on a surface of a porous support; and a second ZIFs part embedded in the porous support, wherein the second ZIFs part is formed in a state in which it penetrates from an interface between the first ZIFs part and the second ZIFs part to a predetermined depth.

2. The porous membrane of claim 1, wherein the first ZIFs portion has a thickness of 0.1 to 10 micrometers, and the second ZIFs portion is formed by penetrating from an interface between the first ZIFs portion and the second ZIFs portion to a depth of 10 to 500 micrometers.

3. The porous membrane of claim 1, wherein the first ZIFs portion and the second ZIFs portion are formed by pre-depositing and immobilizing a Zn precursor on the surface and inside of the porous support using a zinc salt solution of a first concentration, and then reacting the porous support on which the Zn precursor has been pre-deposited and immobilized with an imidazole or imidazole derivative solution.

4. The porous membrane of claim 3, wherein the first concentration is in a range of 0.27 M to 0.58 M.

5. The porous membrane of claim 3, wherein the pre-deposition and the immobilization of the Zn precursor are performed by immersing the porous support in the zinc salt solution for 1 to 12 hours to adsorb the Zn precursor on the surface and inside of the porous support in advance, and then drying the porous support to which the Zn precursor is adsorbed in advance in a vacuum oven at a temperature of 30 to 200° C. for 1 to 24 hours.

6. The porous membrane of claim 3, wherein the reaction with the imidazole or imidazole derivative solution is performed such that the porous support having the Zn precursor pre-deposited and immobilized thereon is immersed in the imidazole or imidazole derivative solution and then reacted at 50 to 200° C. for 1 to 72 hours to form crystals of the Zn precursor and the imidazole on the surface and inside of the porous support.

7. The porous membrane of claim 3, wherein the zinc salt is at least one selected from the group consisting of zinc nitrate, zinc acetate, zinc chloride, zinc sulfate, zinc bromide, and zinc iodide.

8. The porous membrane of claim 3, wherein the imidazole or imidazole derivative is at least one selected from the group consisting of benzimidazole, 2-methylimidazole, 4-methylimidazole, 2-methylbenzimidazole, 2-nitroimidazole, 5-nitrobenzimidazole, and 5-chlorobenzimidazole.

9. The porous membrane of claim 3, wherein the zinc salt solution or the imidazole or imidazole derivative solution is dissolved in at least one solvent selected from the group consisting of methanol, ethanol, propanol, iso-propanol, tert-butanol, n-butanol, methoxyethanol, ethoxyethanol, dimethylacetamide, dimethylformamide, n-methyl-2-pyrrolidone (NMP), formic acid, nitromethane, acetic acid, and distilled water.

10. The porous membrane of claim 1, wherein the surface of the porous support may be polished a predetermined number of times, and even when the surface of the porous support is polished 20 to 100 times, a H₂/CO₂ separation coefficient of 3.1 to 3.8 at 200° C. is exhibited.

11. The porous membrane of claim 1, wherein the separation performance is maintained at 300 to 360° C. for 36 to 168 hours.

12. A method of separating hydrogen from a mixed gas or a syngas of H₂ and CO₂ using the porous separation membrane according to claim 1.

13. The method for separating hydrogen according to claim 12, which is carried out at a temperature of 100 to 500° C.

14. A manufacturing method of a porous membrane, the method comprising:
pre-depositing and immobilizing a Zn precursor on a surface and inside of a porous support using a zinc salt solution having a first concentration; and
reacting the porous support on which the Zn precursor has been pre-deposited and immobilized with an imidazole or an imidazole derivative solution,
wherein a first ZIFs portion is formed on the surface of the porous support, a second ZIFs portion is embedded in the inside of the porous support, and the second ZIFs portion is formed to penetrate from an interface between the first ZIFs portion and the second ZIFs portion by a predetermined depth.

15. The manufacturing method of a porous membrane of claim 14, wherein the first ZIFs portion has a thickness of 0.1 μm to 10 μm, and the second ZIFs portion is formed to penetrate from an interface between the first ZIFs portion and the second ZIFs portion to a depth of 10 μm to 500 μm.

16. The manufacturing method of a porous membrane of claim 14, wherein the first concentration is in the range of 0.27 M to 0.58 M.

17. The manufacturing method of a porous membrane of claim 14, wherein the pre-deposition and immobilization of the Zn precursor is performed by immersing the porous support in the zinc salt solution for 1 to 12 hours to pre-adsorb the Zn precursor on the surface and inside of the porous support, and then drying the porous support to which the Zn precursor is pre-adsorbed in a vacuum oven at a temperature of 30 to 200° C. for 1 to 24 hours.

18. The manufacturing method of a porous membrane of claim 14, wherein the reaction with the imidazole or imidazole derivative solution is performed such that the porous support having the Zn precursor pre-deposited and immobilized thereon is immersed in the imidazole or imidazole derivative solution and then reacted at 50 to 200° C. for 1 to 72 hours to form crystals of the Zn precursor and imidazole on the surface and inside of the porous support.

19. The manufacturing method of a porous membrane of claim 14, wherein the zinc salt is at least one selected from the group consisting of zinc nitrate, zinc acetate, zinc chloride, zinc sulfate, zinc bromide, and zinc iodide.

20. The manufacturing method of a porous membrane of claim 14, wherein the imidazole or imidazole derivative is at least one selected from the group consisting of benzimidazole, 2-methylimidazole, 4-methylimidazole, 2-methylbenzimidazole, 2-nitroimidazole, 5-nitrobenzimidazole, and 5-chlorobenzimidazole.

21. The manufacturing method of a porous membrane of claim 14, wherein the zinc salt solution or the imidazole or imidazole derivative solution is dissolved in at least one solvent selected from the group consisting of methanol, ethanol, propanol, iso-propanol, tert-butanol, n-butanol, methoxyethanol, ethoxyethanol, dimethylacetamide, dimethylformamide, n-methyl-2-pyrrolidone (NMP), formic acid, nitromethane, acetic acid, and distilled water.

22. The manufacturing method of a porous membrane of claim 14, wherein the surface of the porous support may be polished a predetermined number of times, and when the surface of the porous support is polished 20 to 100 times, a H₂/CO₂ separation coefficient of 3.1 to 3.8 is exhibited at 200° C.

23. The manufacturing method of a porous membrane of claim 14, wherein separation performance is maintained at 300 to 360° C. for 36 to 168 hours.
